(19) United States
(12) Patent Application Publication
(10) Pub. No.: US 2007/0114344 A1
(43) Pub. Date: May 24, 2007

(54) Flexible stand assembly

(76) Inventor: Jon Sage, Miami Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/542,418

(22) Filed: Oct. 3, 2006

Related U.S. Application Data
(63) Continuation-in-part of application No. 10/917,630, filed on Aug. 13, 2004, now abandoned.

(51) Int. Cl. F16M 13/00

(52) U.S. Cl. 248/160

(57) ABSTRACT

A portable flexible support pedestal is disclosed having an upper portable unit support surface and a lower attachment surface, the upper portable unit support surface for supporting a portable unit, an elongate flexible member having an upper end and a lower end, the upper end operatively engaged to the lower attachment surface, the elongate flexible member resiliently flexible into a plurality of retainable positions, and a base member operatively engaged to the lower end, the base member maintaining balance of the portable unit support pedestal.

### CROSS REFERENCE TO RELATED APPLICATIONS

The present application is a continuation-in-part of U.S. patent application Ser. No. 10/917,630 filed on Aug. 13, 2004, which is incorporated in its entirety herein by reference.

### TECHNICAL FIELD OF THE INVENTION

The present invention relates to devices used to support portable controls for electronic equipment and more particularly to devices used to support and organize multiple portable controls for electronic equipment wherein the portable controls are of various sizes and shapes.

### BACKGROUND OF THE INVENTION

For many years, consumer electronic devices such as televisions, stereos, videocassette recorders, compact disc players and tape cassette players have enjoyed increased development of portable control systems to the point where virtually all such devices are available with portable or remote control capability. The fabrication and design of such portable control units has become extremely commonplace and most include a small elongated and relatively thin plastic housing having an upper face supporting a plurality of control buttons and an internally supported battery powered infrared information sending device. Typically, on the receiving consumer electronic device, a responsive receiver decoder interprets the encoded signals and decodes the encoded operational command producing the desired result in the unit itself.

Such portable control units initially were implemented as relatively large, often cumbersome devices. However, the continued application of advancing technology has produced control devices that are becoming smaller. In addition, the number of control features within the portable control hand unit itself has greatly increased since the technology has been refined.

Concurrent with the development of smaller and more sophisticated control units, the general increase in the number of consumer electronic devices utilizing portable control has increased dramatically. With this increased popularity and use, the portable control unit has transitioned from an optional, often luxury, item on a consumer electronic device to commonplace standard equipment. In line with this marketplace and product transition, consumer electronic devices have become configured and designed in anticipation of portable control operation rather than the manipulation of a plurality of front cabinet buttons, knobs and other controls. Thus, consumers no longer utilize such portable control units sparingly but rather depend upon them as their main interface with the consumer electronic device.

The result of all this has been a virtual explosion in the proliferation of small, compact, lightweight, and portable control units. The typical home today will likely have two, three or more of such devices in use within any recreation or entertainment room. One of the problems with such portable control units is their tendency to become misplaced as consumers move about the room in other activities. Beyond this, a plurality of such portable control units collected upon a single table or the like often give the tabletop a cluttered look which users find undesirable but seem to have accepted as a fact of high technology life.

The increasing number of consumer electronic devices having a portable control has created a portable control-organizing problem in many homes. Because these portable controls come in various sizes and shapes, it is often difficult to find a satisfactory way of organizing them. It would be a benefit, therefore, to have a portable organizing device or stand that allowed multiple portable units to be stored and organized. It would be of further benefit if the stand could accommodate a variety of different shaped and sized portable units without having to be modified.

There remains, therefore, a need in the art for devices that will properly organize and coordinate the use of such multiple portable control units while facilitating their collection at a common place. In particular, there is a need for a portable and flexible stand construction that can be utilized for supporting a portable unit or other device in a vast array of orientations with respect to a user.

### SUMMARY OF THE INVENTION

In view of the foregoing disadvantages inherent in the known types of portable control stands now present in the prior art, the present invention provides a new portable flexible stand construction wherein the same can be utilized for supporting a portable unit or other device above a floor surface so that the portable unit is easily retrievable by a user.

The general purpose of the present invention, which will be described subsequently in greater detail, is to provide a new portable flexible stand apparatus and method which has many of the advantages of the portable control stands mentioned heretofore and many novel features that result in a new portable flexible stand which is not anticipated, rendered obvious, suggested, or even implied by any of the prior art portable control stands, either alone or in any combination thereof.

To attain this, the present invention generally includes a portable unit support pedestal having an upper portable unit support surface and a lower attachment surface, the upper portable unit support surface for supporting a portable unit, an elongate flexible member having an upper end and a lower end, the upper end operatively engaged to the lower attachment surface, the elongate flexible member resiliently flexible into a plurality of retainable positions; and a base member operatively engaged to the lower end, the base member maintaining balance of the portable unit support pedestal.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new portable flexible stand apparatus and method which has many of the advantages of the portable control stands mentioned heretofore and many novel features that result in a new portable flexible stand which is not anticipated, rendered obvious, suggested, or even implied by any of the prior art portable control stands, either alone or in any combination thereof.

It is another object of the present invention to provide a new portable flexible stand that may be easily and efficiently manufactured, assembled, and disassembled.

It is another object of the present invention to provide a new portable flexible stand that is aesthetically pleasing.

It is a further object of the present invention to provide a new portable flexible stand that is of a durable and reliable construction.

Still yet another object of the present invention is to provide a new portable flexible stand that provides the apparatuses and methods of the prior art some of the advantages thereof, while simultaneously overcoming some of the disadvantages normally associated therewith.

Still another object of the present invention is to provide a new portable flexible stand for supporting a portable unit above a floor surface so that the portable unit is easily retrievable and accessible by a user.

Still yet another object of the present invention is to provide a new portable flexible stand that is ideal for holding television, videocassette player and stereo portable controls, PDA's, medical and baby monitors, game controllers, cellular and portable telephones, laptop computers, glasses, books, and other objects proximal to a user's seat or location so that the user can easily engage the portable unit when needed.

Even still another object of the present invention is to provide a new portable flexible stand that helps eliminate the loss of portable units and reduces the time spent looking for missing portable units.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an isometric view illustration of a new portable flexible stand in accordance with the preferred embodiment of the present invention.

FIG. 2 is an isometric view illustration of the present invention of FIG. 1.

FIG. 3 is a side view illustration of the present invention of FIG. 1.

FIG. 4 is a side view illustration of an alternative embodiment of the support pedestal of FIG. 3.

FIG. 5 is an isometric view illustration of another alternative embodiment of the support pedestal of FIG. 3.

FIG. 6 is an isometric view illustration of yet another alternative embodiment of the support pedestal of FIG. 3.

FIG. 7 is an isometric view illustration of still another alternative embodiment of the support pedestal of FIG. 3.

### DESCRIPTION OF THE PREFERRED EMBODIMENT

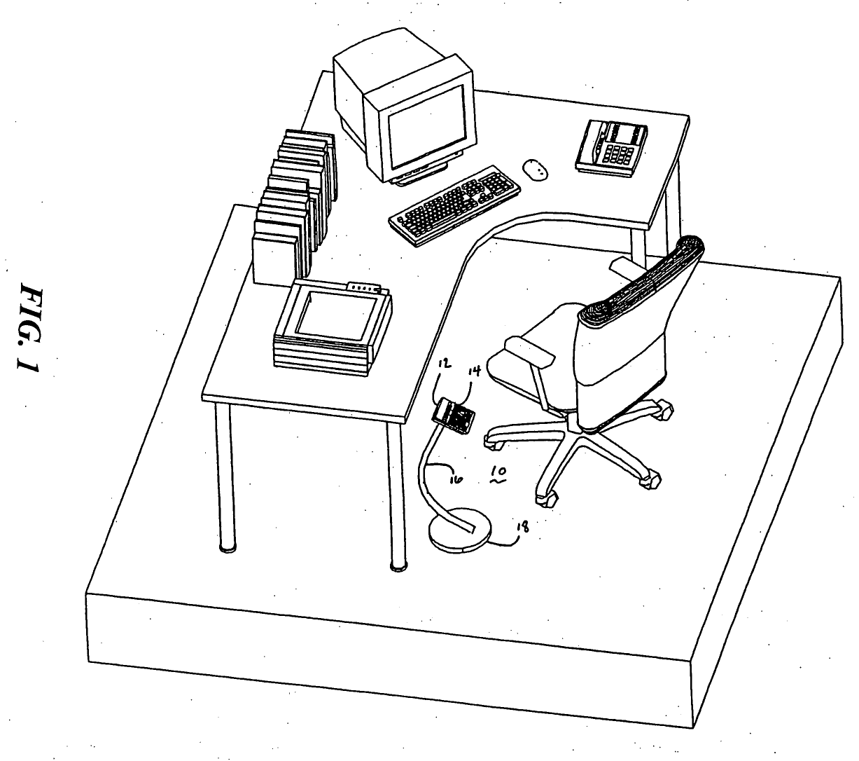

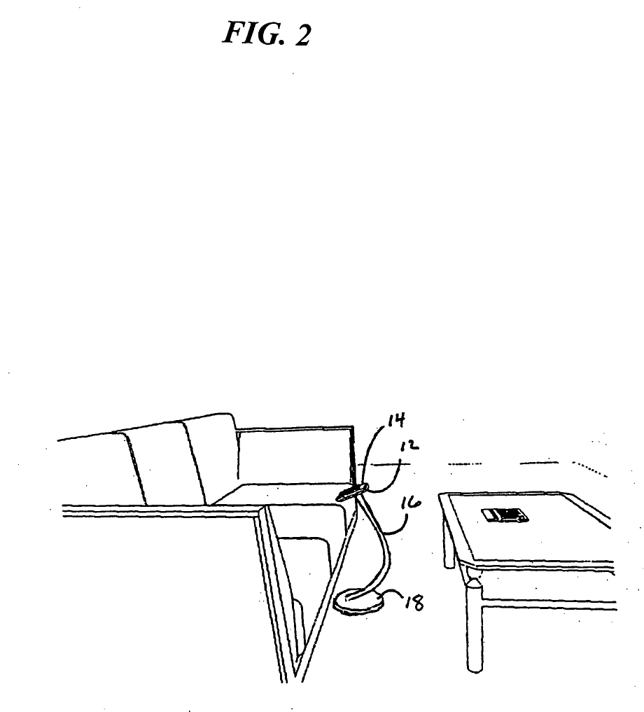

Referring now to FIGS. 1 and 2, the preferred embodiment of the present invention is illustrated as support stand 10. It is preferred that support stand 10 include a portable unit support pedestal 12, an elongate flexible member 16, and a base 18.

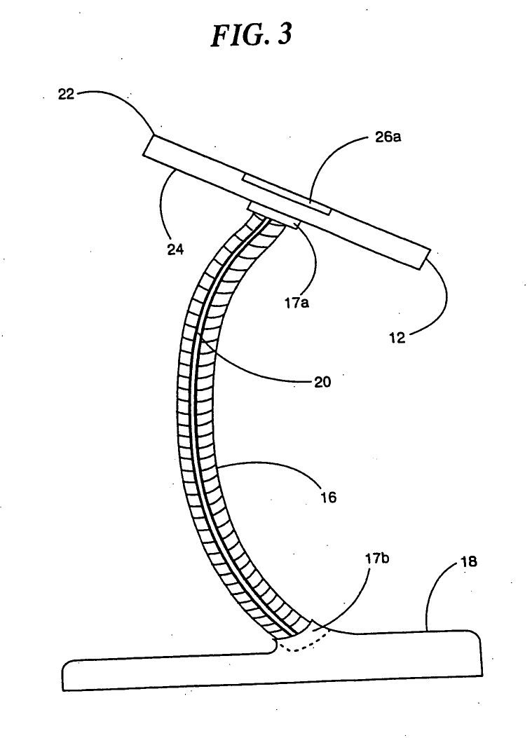

As is shown in FIGS. 1 and 2, portable unit support pedestal 12 is operatively engaged to elongate flexible member 16. Additionally, as further illustrated in FIG. 3, elongate flexible member 16 includes an upper end 17a and a lower end 17b. The operative engagement between upper end 17a of elongate flexible member 16 and portable unit support pedestal 12 is preferably a selectively releasable engagement, allowing quick assembly and disassembly. Such a selectively releasable engagement permits a plurality of elongate flexible members to be coupled to one another at respective upper ends 17a and lower ends 17b so as to lengthen the distance between portable unit support pedestal 12 and base 18, as desired by the user.

As is further illustrated in FIG. 3, portable unit support pedestal 12 further includes an upper portable control support surface 22 and a lower attachment surface 24. Upper portable control support surface 22 can include a securing member 26a to releasably secure the portable control unit 14. Preferably, securing member 26a permits the user to easily and releasably affix portable control unit 14 to upper portable control support surface 22 of portable unit support pedestal 12. In this way, the user can engage portable control unit 14 either on portable unit support pedestal 12 or by removing portable control unit 14 therefrom.

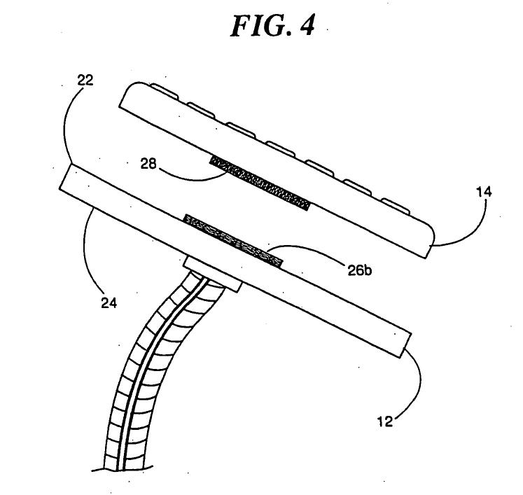

Referring now to FIGS. 3 and 4, various securing members 26a and 26b are illustrated. As is shown in FIG. 3, securing member 26a is incorporated into portable unit support pedestal 12. As such, securing member 26a can be magnetic, thereby utilizing magnetic forces to releasably secure portable control unit 14. In situations where the application of magnetic forces is undesirable, such as with PDA's, laptop computers, and the like, alternative securing members, such as securing member 26b (illustrated in FIG. 4) can be employed.

Securing member 26b can be any one of an array of materials known in the art, however, for the purposes of example, securing member 26b is one half of a hook-and-loop type fastener. As such, securing member 26b is affixed to upper portable control support surface 22 of portable unit support pedestal 12. Opposing half 28 is affixed to portable control unit 14, thereby allowing portable control unit 14 to be releasably secured to upper portable control support surface 22 of portable unit support pedestal 12 by way of the mating of securing member 26b and opposing half 28.

In an alternative embodiment, securing member 26b could be a non-skid surface, such as rubber. Such a non-skid surface preferably has a coefficient of friction sufficient to reduce or prevent portable control unit 14 (or other object) from undesired slippage on upper portable control support surface 22 of portable unit support pedestal 12.

Referring again to FIG. 3, base 18 is illustrated in operative engagement to lower end 17b of elongate flexible member 16. The diameter of elongate flexible member 16 is preferably optimized to support intended portable devices.

Base 18 is preferably constructed so as to maintain balance of portable unit support pedestal 12, and, more preferably, to maintain the balance of portable unit support pedestal 12 having portable control unit 14 or units thereon. Base 18 can be weighted so as to properly maintain such balance. Other manners of maintaining such balance can be employed as is well known in the art, including, but not limited to clamps and folding legs.

In operation, elongate flexible member 16 is preferably resiliently flexible into a plurality of retainable positions. Thus, portable control unit 14 can be placed in a variety of positions with respect to the user, each position advantageous for engaging portable control unit 14 for the user when in a particular position.

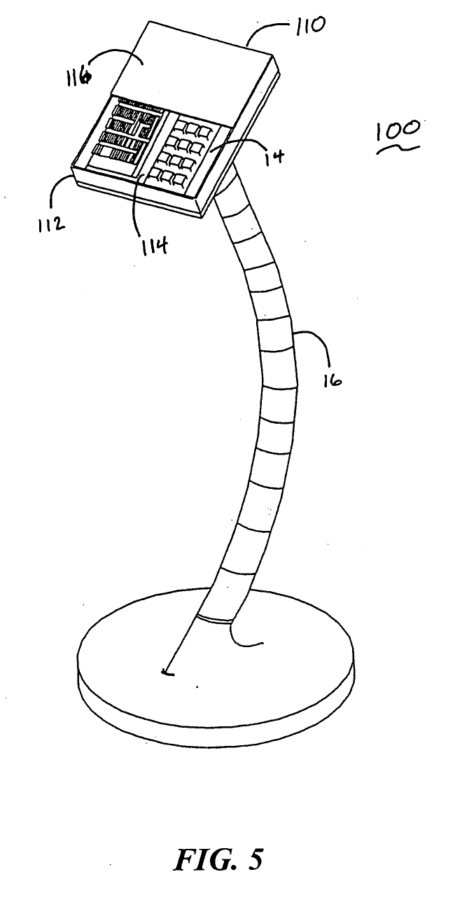

Referring now to FIG. 5, an alternative embodiment of the present invention is illustrated as flexible stand 100. Flexible stand 100 incorporates a containing member 110 for holding or otherwise containing at least one portable control unit 14. In operation, containing member 110 has a plurality of containment walls that are operatively engaged so as to form an enclosure 114. Enclosure 114 receives at least one portable control unit 14. An upper enclosure cover 116 covers a portion of enclosure 114, so as to prevent at least one portable control unit 14 from being displaced out of enclosure 114 when elongate flexible member 16 is positioned or repositioned. Upper enclosure cover 116 additionally provides the user with an aesthetically pleasing alternative to an open enclosure 114. Upper enclosure cover 116 may additionally be hingedly or slidably connected to enclosure 114, so as to facilitate unencumbered removal of at least one portable control unit 14 from enclosure 114.

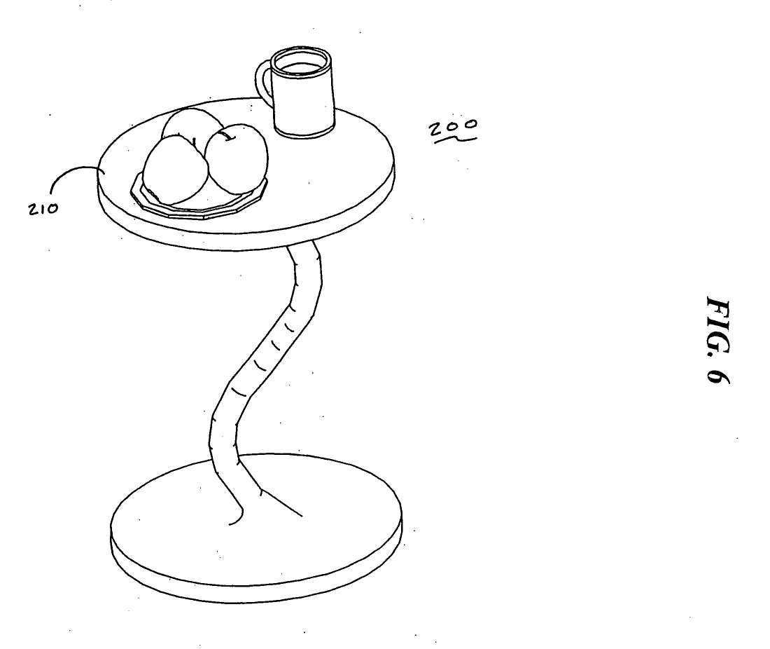

Referring now to FIG. 6, an additional alternative embodiment is illustrated as flexible table stand 200. Flexible table stand 200 can incorporate a table-like support 210 that can be used to support objects such as vases, drinking glasses, books and the like.

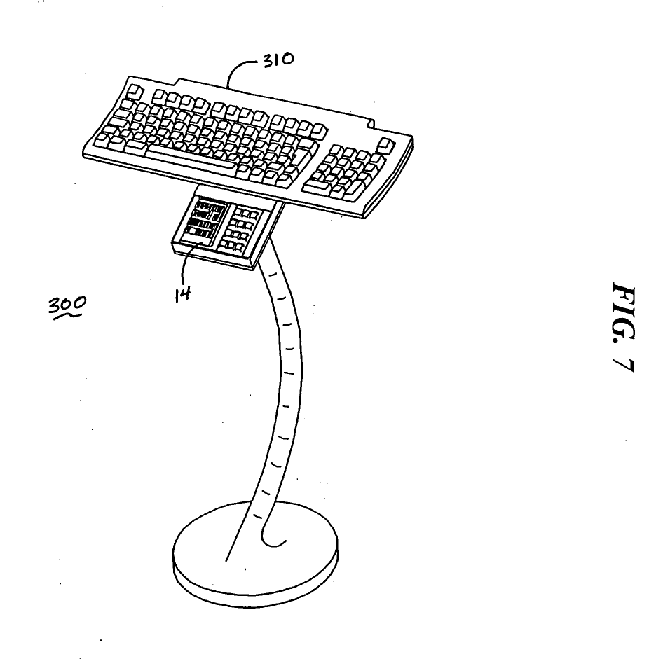

Referring now to FIG. 7, yet another alternative embodiment is illustrated as flexible stand 300. Flexible stand 300 can be used to support a keyboard 310 or similar large object, and/or portable control unit 14.

Although only a few exemplary embodiments of the present invention have been described in detail above, those skilled in the art will readily appreciate that numerous modifications to the exemplary embodiments are possible without materially departing from the novel teachings and advantages of this invention. Accordingly, all such modifications are intended to be included within the scope of this invention as defined in the following numbered claims.

What is claimed is:

1. A flexible stand assembly for portable units, comprising:
a portable control support pedestal having an upper portable control support surface and a lower attachment surface, said upper portable control support surface for supporting an object;
an elongate flexible member having an upper end and a lower end, said upper end operatively engaged to said lower attachment surface, said elongate flexible member resiliently flexible into a plurality of retainable positions; and
a base member operatively engaged to said lower end, said base member maintaining balance of said portable control support pedestal.

2. The support assembly according to claim 1 wherein said upper portable control support pedestal incorporates a securing member.

3. The support assembly according to claim 2 wherein said securing member is magnetic.

4. The support assembly according to claim 2 wherein said securing member is at least one half of a hook and loop fastener.

5. The support assembly according to claim 2 wherein said securing member is a non-skid material.

6. The support assembly according to claim 5 wherein said non-skid material is rubber.

7. The support assembly according to claim 1 wherein said upper end of said elongate flexible member is in a selectively releasable engagement with said lower attachment surface of said portable control support pedestal.

8. The support assembly according to claim 1 wherein said lower end of said elongate flexible member is in a selectively releasable engagement with said base member.

9. The support assembly according to claim 1 wherein said base is weighted.

10. The support assembly according to claim 1 wherein said base incorporates a clamp.

11. The support assembly according to claim 1 wherein said base incorporates at least one folding leg.
